(19) United States
(12) Patent Application Publication
(10) Pub. No.: US 2013/0127122 A1
(43) Pub. Date: May 23, 2013

(54) FLAT COMPONENT HAVING FUNCTIONAL ELEMENTS AND METHOD FOR PRODUCING SAME

(71) Applicant: Kristian Muller-Niehuus, Hamburg (DE)

(72) Inventor: Kristian Muller-Niehuus, Hamburg (DE)

(21) Appl. No.: 13/811,541

(22) PCT Filed: May 18, 2011
(86) PCT No.: PCT/EP2011/058014

§ 371 Date: Jan. 22, 2013

(30) Foreign Application Priority Data
Aug. 24, 2010 (DE) 102010039681.8

(51) Int. Cl. F02F 11/00

(52) U.S. Cl. CPC F02F 11/002
USPC 277/591; 29/418

(57) ABSTRACT

A method for producing a flat component having at least one functional element, includes providing a blank for the at least one functional element, shaping the at least one functional element from the blank, providing the functional layer which is to have the at least one functional element, and arranging the at least one functional element on the functional layer and fastening the at least one functional element on the functional layer. A resultant flat component having the at least one functional element is further provided.

The present invention relates to an improved method for producing flat components having functional elements, in particular flat gaskets, and correspondingly produced flat components.

Flat gaskets having functional elements are used in various fields in the automotive industry, for example as cylinder head gaskets or exhaust gaskets. Both types of gasket can for example have functional elements such as hinterland stoppers or combustion chamber stoppers or insertion parts. Steel gaskets and inserted elastomer gaskets for example are in particular used in the commercial vehicle field.

A combustion chamber stopper, i.e. a stopper in the direct vicinity of the combustion chamber for protecting a combustion chamber sealing bead from complete flattening may be mentioned as an example of such a functional element. Among other things, stoppers are currently punched out of flat material, which causes considerable production of waste, and welded to the cylinder head gasket in a relatively slow welding process. The flat component (e.g. flat gasket) consists of one or a plurality of functional layers, which has no, one or a plurality of functional elements.

For hinterland stoppers there is the possibility of stamping the hinterland stopper into the functional layer e.g. of a cylinder head gasket. This results in turn in a disadvantageous high stress and thus potentially weakening of the material by the stamping process. Furthermore, stamped stoppers are disadvantageous in that stamped stoppers have an elastic/plastic deformation characteristic, limited rigidity and a pronounced material fatigue behaviour.

The object of the present invention therefore consists in proposing a method for producing flat components, in particular flat gaskets, which avoids waste, preserves the gasket material, optimises function and is cost-effective. Furthermore, the method according to the invention should allow the material which is optimal in each case to be used for functional elements such as hinterland or combustion chamber stoppers or insertion parts and for the corresponding functional elements to be applied in the optimal forms and exactly at the required points.

According to a first aspect of the invention, a method for producing a flat component having at least one functional element is provided, comprising:
providing a blank for the at least one functional element consisting of flat or bar material;
shaping the at least one functional element from the blank;
providing the functional layer which is to have the at least one functional element;
arranging the at least one functional element on the functional layer; and
fastening the at least one functional element on the functional layer.

The invention allows prior production of all the necessary functional elements (e.g. hinterland or combustion chamber stopper) in an optimal, use-specific form and consisting of an optimal, use-specific material from a blank, in particular consisting of flat or bar material. This invention can be applied to metallic blanks consisting of foils, plates, coils, precision strip steel, flat or bar material and similar available forms.

These metallic materials, also referred to below as basic metal, which are typically used in the production of gaskets and gasket rings, comprise low, medium and high carbon steel, carbon steel mixtures, stainless steel, copper and copper alloys, aluminium and aluminium alloys, nickel alloys, cobalt alloys, and plastics and elastomers or similar materials.

The basic metal can furthermore have a coating with another metal or an alloy, which is typically produced by plating, sheathing, physical vapour deposition, chemical vapour deposition, baking e.g. by plasma or similar methods, chemical reaction of the surface of the basic metal and/or by other methods.

The basic metal furthermore often has a coating having organic or synthetic materials consisting of polymers, polymer mixtures, elastomers, elastomer mixtures/compounds and/or other materials.

This invention can be applied to components, parts or assembled objects consisting of the described metallic materials.

The separate production of the functional elements allows the selection of a material which is different from the basic flat components or functional layer.

According to the invention, a serial automatic population of the provided functional elements (e.g. hinterland or combustion chamber stoppers) follows, for instance with the aid of a pick-and-place machine, directly onto the functional layer (e.g. cylinder head gasket or exhaust gasket). According to the corresponding positioning, the connection between the functional layer and the functional element(s) is made in a force-fitting or form-fitting or materially cohesive manner, e.g. by welding, adhesive bonding, sintering, soldering, vulcanising, riveting, crimping, baking or similar methods.

The invention thereby has the following advantages:
1) Cost savings, as functional elements can be produced while avoiding waste.
2) Increase in cycles per time unit.
3) Material conservation, as the basic component structure is not adversely affected by stamping or drawing in contrast to stamped stoppers.
4) In contrast to stamped stoppers having elastic/plastic characteristics, limited rigidity and pronounced material fatigue behaviour, those with ideally rigid characteristics can be used.
5) Use of optimal materials. Instead of “all-in-one” solutions, in which all or at least most of the involved functional elements of the flat component are integrated in the functional layer and thus consist of the same material as the functional layer, which always entails compromises, functional elements matched to the respective application and consisting of the optimal material for the application can be applied with the invention.
6) Use of optimal geometries. With the invention, functional elements which are matched to the respective application can be applied in a targeted manner only at the required points can in the respectively optimal geometry (e.g. ellipse, circle, rectangle, square, trapezium, polygon and irregularly shaped).
7) New design possibilities. The invention allows a more compact construction, as functional elements can also be applied at positions of the basic component where e.g. a stamping process of the component is not possible owing to geometric conditions (thickness, width, adjacent functional elements).

According to one embodiment, the one or plurality of functional elements are arranged by means of a pick-and-place device. According to the invention, a pick-and-place device means a device which can pick up, position and/or fasten one or a plurality of functional elements and/or one or a plurality of supports substantially manually, semi-automatically or (fully) automatically.

According to one embodiment, the arrangement of the one or plurality of functional elements takes place serially (i.e. consecutively) and the connection and/or fastening of the functional elements to the functional layer takes place either serially subsequently or directly after positioning. The term “subsequently” refers according to the invention to a time after the arrangement of all the relevant functional elements, i.e. after the last functional element has been arranged. In contrast to this, serial connection directly after positioning refers to an embodiment in which, after an individual functional element has been arranged, this element is connected first, before the next one is arranged, and so on.

According to an alternative embodiment, the arrangement of the one or plurality of functional elements takes place serially (i.e. consecutively) and the connection of the functional elements to the functional layer takes place subsequently substantially in parallel.

According to an alternative embodiment, the arrangement of the one or plurality of functional elements takes place substantially in parallel and the connection of the functional elements to the functional layer takes place subsequently serially.

According to an alternative embodiment, the arrangement of the one or plurality of functional elements takes place substantially in parallel and the connection of the functional elements to the functional layer takes place subsequently substantially in parallel.

According to one embodiment
the flat component should have at least two functional elements; and
the arrangement of the at least two functional elements on the functional layer takes place consecutively.

According to an alternative embodiment
the flat component should have at least two functional elements; and
the arrangement of the at least two functional elements on the functional layer takes place substantially in parallel.

According to one embodiment, the method further comprises
arranging the one or plurality of functional elements, after forming from the blank, on a support in positions corresponding to the intended positions of the functional elements on the functional layer;
   wherein the arrangement of the one or plurality of functional elements on the functional layer takes place by means of the support; and
   the method further comprises
optimal removal of the support after the one or plurality of functional elements have been fastened to the functional layer.

The use of a single- or multi-use support for transferring the prefabricated functional elements positioned on the support advantageously allows the substantially simultaneous population of the functional layer, as a result of which the process time can be reduced. In the case of multi-use supports, these can be used for further pick-and-place processes of further components.

According to one embodiment, the support is a single- or multi-use support consisting of cardboard, foil, natural or synthetic cloth or material.

According to one embodiment, the fastening of the one or plurality of functional elements to the functional layer takes place by means of the material used and with the use of suitable customary welding methods (e.g. ultrasonic welding, projection welding, gas fusion welding, arc welding, gas-shielded welding, resistance welding, cold pressure welding, friction welding, submerged arc welding, laser beam welding, electron beam welding, diffusion welding).

According to one embodiment, the one or plurality of functional elements comprise at least one of combustion chamber stopper, hinterland stopper, spacer, elastomer component, bead, semi-bead and insertion part.

According to one embodiment, the blank consists of foils, plates, coils, precision strip steel, flat or bar material, or combinations thereof.

According to one embodiment, the material of the blank comprises low, medium and high carbon steel, carbon steel mixtures, stainless steel, copper and copper alloys, aluminium and aluminium alloys, nickel alloys, cobalt alloys, and plastics and elastomers, or a combination thereof.

According to one embodiment, the blank is metallic, preferably consisting of a material such as that of the two above-mentioned embodiments, and the blank has a coating with another metal or an alloy, which is produced by plating, sheathing, physical vapour deposition, chemical vapour deposition, baking, baking by means of plasma, or chemical reaction of the surface of the basic metal.

According to one embodiment, the blank has, alternatively to or in combination with the above-mentioned embodiment a coating with organic or synthetic materials consisting of polymers, polymer mixtures, elastomers, elastomer mixtures or combinations thereof.

According to a second aspect of the present invention, a flat component is provided, which is produced according to a method as described above.

According to one embodiment, the flat component is a (for example metallic) exhaust or cylinder head gasket or a soft material exhaust gasket or cylinder head gasket.

### SHORT DESCRIPTION OF THE FIGURES

FIG. 1 shows a first embodiment of a method according to the invention; and

FIG. 2 shows an alternative second embodiment of a method according to the invention.

### DETAILED DESCRIPTION OF THE INVENTION

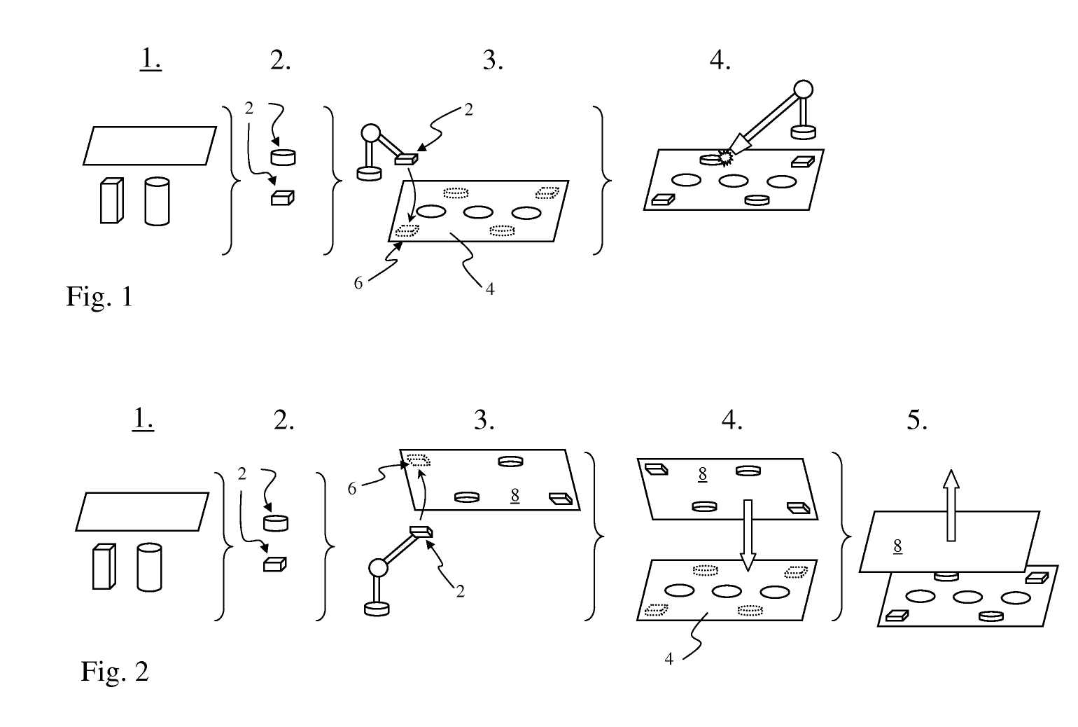

FIG. 1 shows a first embodiment of a production method according to the invention for flat components having functional elements (e.g. hinterland or combustion chamber stoppers). In a 1st step, the blanks are provided for the functional elements, for example flat or bar materials, shown schematically here. In step 2, the prefabricated functional elements 2 are shown schematically.

In step 3, the base (or functional layer) 4 on which the flat component is based is provided, the prefabricated functional elements 2 are arranged at the intended population positions 6 (shown dashed here) by means of a pick-and-place device. This population process can take place in particular serially in this embodiment, i.e. consecutively in the case of a plurality of functional elements.

In step 4, the functional elements arranged on the component base 4 are fastened to the component base 4, shown in this case by way of example as a welding process. The flat component is then finished.

FIG. 2 shows an alternative second embodiment of a production method according to the invention for flat components having functional elements. Steps 1 and 2 are analogous to the embodiment of FIG. 1.

In contrast, a support 8 is provided in step 3. The prefabricated functional elements 2 are arranged (serially or substantially in parallel) on the support at population positions 6 (in this case only one, the other functional elements are already at the intended position), in a mirrored alignment in relation to the intended arrangement on the flat component.

In step 4, the base 4 on which the flat component is based is provided. The prefabricated functional elements 2 are arranged at the intended population positions (shown dashed here) by means of the support 8 holding them by means of a pick-and-place device (not shown). This population process can take place in particular in this embodiment substantially in parallel, i.e. a plurality of functional elements is transferred together onto the component base or functional layer 4 by means of the support. The support 8 can be a cardboard, foil, a natural or synthetic cloth or material and be intended for single or multiple use.

After the applied functional elements have been fastened (not shown here, but carried out analogously to FIG. 1 for example likewise by means of serial or substantially simultaneous welding), the support 8 is detached from the functional elements and removed; alternatively, the support can remain on the flat component (not shown here). In the case of multi-use supports, it can be used again for subsequent pick-and-place processes. The flat component with integrated functional elements is then finished.

The invention provides a production method for flat components with functional elements which saves costs and avoids waste. The method furthermore has increased throughput per unit time. In comparison with flat components with stamped functional elements, the component structure is prevented from being adversely affected with the method according to the invention.

The separate prefabrication of functional elements makes greater flexibility possible, as the functional elements can be produced from use-specific materials and in use-specific form. The possibility of providing functional elements even in very narrow or thin areas of the basic component with the method according to the invention opens up new design possibilities.

1. A method for producing a flat component having at least one functional element, comprising:
providing a blank for the at least one functional element;
shaping the at least one functional element from the blank;
providing the functional layer which is to have the at least one functional element;
arranging the at least one functional element on the functional layer; and
fastening the at least one functional element on the functional layer.

2. The method according to claim 1, wherein the one or plurality of functional elements are arranged by means of a pick-and-place device.

3. The method according to claim 1 or 2, wherein
the arrangement of the one or plurality of functional elements takes place serially or substantially in parallel; and
the fastening of the one or plurality of functional elements to the functional layer takes place serially or substantially in parallel.

4. The method according to claim 1, 2 or 3, further comprising:
arranging the one or plurality of functional elements, after forming from the blank, on a support in positions corresponding to the intended positions of the functional elements on the functional layer;
wherein the arrangement of the one or plurality of functional elements on the functional layer takes place by means of the support.

5. The method according to claim 4, further comprising
removal of the support after the one or plurality of functional elements have been fastened to the functional layer.

6. The method according to one of the preceding claims, wherein the support is a single- or multi-use support consisting of cardboard, foil, natural or synthetic cloth or material.

7. The method according to one of the preceding claims, wherein the fastening of the one or plurality of functional elements to the functional layer takes place in a force-fitting, form-fitting or materially cohesive manner by welding, adhesive bonding, sintering, soldering, vulcanising, riveting, crimping, baking or similar methods.

8. The method according to one of the preceding claims, wherein the flat component is a metallic exhaust gasket or cylinder head gasket or a soft material exhaust gasket or cylinder head gasket.

9. The method according to one of the preceding claims, wherein the one or plurality of functional elements comprise at least one of combustion chamber stopper, hinterland stopper, spacer, elastomer component, bead, semi-bead and insertion part.

10. The method according to one of the preceding claims, wherein the blank consists of foils, plates, coils, precision strip steel, flat or bar material, or combinations thereof.

11. The method according to one of the preceding claims, wherein the material of the blank comprises low, medium and high carbon steel, carbon steel mixtures, stainless steel, copper and copper alloys, aluminium and aluminium alloys, nickel alloys, cobalt alloys, and plastics and elastomers, or a combination thereof.

12. The method according to one of the preceding claims, wherein the blank is metallic and preferably consists of foils, plates, coils, precision strip steel, flat or bar material, or combinations thereof, wherein the material of the blank preferably comprises low, medium and high carbon steel, carbon steel mixtures, stainless steel, copper and copper alloys, aluminium and aluminium alloys, nickel alloys, cobalt alloys, or a combination thereof, and wherein the blank has a coating with another metal or an alloy, which is produced by plating, sheathing, physical vapour deposition, chemical vapour deposition, baking, baking by means of plasma, or chemical reaction of the surface of the basic metal.

13. The method according to one of the preceding claims, wherein the blank is metallic and preferably consists of foils, plates, coils, precision strip steel, flat or bar material, or combinations thereof, wherein the material of the blank preferably comprises low, medium and high carbon steel, carbon steel mixtures, stainless steel, copper and copper alloys, aluminium and aluminium alloys, nickel alloys, cobalt alloys, or a combination thereof, and wherein the blank has a coating with organic or synthetic materials consisting of polymers, polymer mixtures, elastomers, elastomer mixtures or combinations thereof.

14. A flat component produced using a method according to one of the preceding claims.

15. The flat component according to claim 14, wherein the flat component is an exhaust gasket or a cylinder head gasket.
